(19) United States
(12) Patent Application Publication
(10) Pub. No.: US 2009/0307417 A1
(43) Pub. Date: Dec. 10, 2009

(54) INTEGRATED BUFFER DEVICE

(75) Inventor: Srdjan Djordjevic, Muenchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 12/134,380

(22) Filed: Jun. 6, 2008

(51) Int. Cl. G06F 12/06; G06F 3/00

(52) U.S. Cl. 711/105; 710/14; 711/E12.083

(57) ABSTRACT

An integrated buffer device. One embodiment provides a receiving unit and a logic unit to control the operation of the buffer device based on a setting signal.

### BACKGROUND

The present invention relates to electronic devices. Today computer, like for instance, servers, workstations or personal computers are continuously enhanced. Accordingly, memory buses connecting memory modules to servers/workstations need to be faster and larger in capacity. To fulfill this need designated integrated circuits were developed which may be used to improve the communication of the memory modules or devices with other circuits like for instance a memory controller or the like. One solution may be a fully buffered DIMM (FB-DIMM) device wherein on each DIMM an advanced memory buffer (AMB) or buffer device is placed. The AMB directly communicates with a memory controller via a high speed interface for instance. The buffer device includes two serial links, one for upstream and the second one for the downstream channel, and a bus to the DRAM modules which are implemented on the DIMM. The data from the memory controller sent through the downstream serial link (southbound) is temporarily buffered, and then sent to the DRAM's. The data contains the address, data and command information which is in turn conveyed to the DRAM devices by using the AMB device. The AMB may also operate as a repeater to interconnect at least two FB-DIMMs.

However there is a need for an improved buffer device.

### SUMMARY

An integrated circuit with buffer device is provided. The buffer device at least includes an interface to be operated according to an operation mode of the buffer device and a receiving unit to receive at least a setting signal. A logic unit to control the operation mode of the buffer device based on the setting signal is provided.

Further features and advantages of the present invention will become apparent from the following detailed description of the invention made with reference to the accompanying drawings.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates one embodiment of a buffer device.

FIG. 2 illustrates a buffer on board implementation according to one embodiment.

FIG. 3 illustrates a buffer on DIMM implementation according to one embodiment.

FIG. 4 illustrates an overview of the functionality of the integrated device according to one embodiment.

FIG. 5 is diagram according to an operation method of the integrated circuit according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

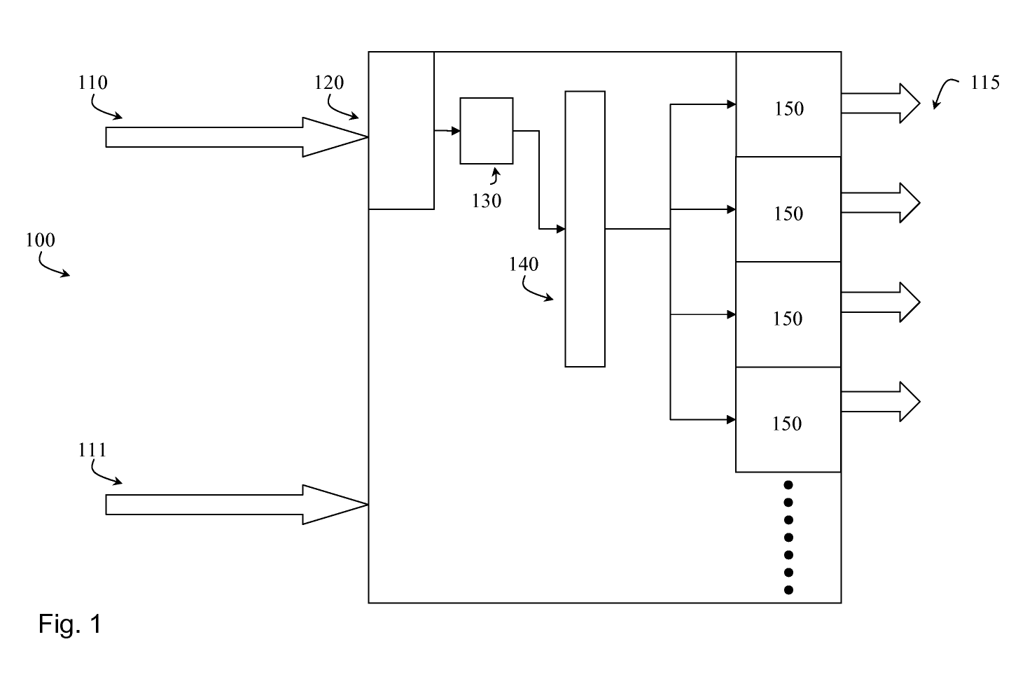

FIG. 1 illustrates one embodiment of a buffer device. Buffer device 100 may be an integrated circuit device used to control and convey data signals to other devices like for instance memory devices.

The buffer device includes a receiving unit 120 configured to receive at least a setting signal 110. Setting signal 110 may be provided by a basic input/output system (BIOS) as may be provided on a separate integrated circuit (not illustrated) associated with buffer device 100. In one embodiment, setting signal 110 may be provided by register circuitry or other flag circuitries or provided directly by a user, for example.

Receiving unit 120 is in turn coupled for signal communication with a logic unit 130. Logic unit 130 is likewise coupled for signal communication with control unit 140 which operates a plurality of control ports 150.

In operation, setting signal 110 is transmitted to receiving unit 120 which in turn provides setting signal 110 to the further devices of buffer device 100. More specifically, logic unit 130 receives setting signal 110 from receiving unit 120 and is configured to provide control unit 140 with operating signals 110a. Control unit 140 may therefore operate control ports 150 of buffer device 100 according to operating signals 110a.

Buffer device 100 may be provided with a high speed interface (not illustrated) to receive a plurality of high speed signals over high speed bus 111. Herein the term “bus” denotes a plurality of signal lines, each having more than two connection points for receiving or transmitting signals or data.

The control ports of the buffer device 100 typically include a plurality of address lines and control signals 115. For the sake of simplicity, the control and address signals are depicted together with reference to reference sign 115 e.g., row address select (RAS), column address select (CAS) and write enable WE, respectively. Additionally buffer device 100 may be coupled with a plurality of memory devices, for example dynamic random access memory (DRAM)-modules or dual in-line memory modules (DIMM's ), depending on the application. According to one embodiment the control signals or bus signals 115 respectively are shared with further memory devices or modules to provide, for example, row or column addressing, read, write, refresh and pre-charge commands to selected memory devices or modules.

The term memory module is understood to refer to a device including a plurality of memory devices such as DRAM or similar memory devices. According to one embodiment buffer device 100 may be interconnected with a plurality of memory modules (DIMM-modules) arranged on a printed circuit board (PCB). The PCB may include a plurality of slots to receive the memory modules for electrical connection during operation.

Further a memory system including one or more buffer devices 100 may be embedded within a data system like a personal computer, host computer, server computer or the like.

The buffer device may also be used to control a plurality of memory devices like DRAM-devices. This operation mode may be called buffer-on-DIMM, which means that the buffer device may be adapted to control each memory device independently. Logic unit 130 within buffer device 100 may be configured to control the mode of operation of buffer device 100. That is, in a first mode of operation buffer device 100 may operate as a controlling device for a plurality of memory modules arranged on a PCB of a data system. Further, in a possible second mode of operation logic unit 130 may switch buffer device 100 to operate as a buffer-on-DIMM device. According to the latter mode of operation the device addresses a plurality of memory devices such as DRAM-devices for example.

Buffer device 100 may include interface 150. Interface 150 may include a plurality of control signals in a group of control ports for instance. According to one embodiment, receiving unit 120 is configured to receive one or more setting signals 110. One of the setting signals is to be conveyed to logic unit 130 which in turn may control the mode of operation of buffer device 100 based on the setting signal.

Buffer device 100 may be configured to communicate with memory controller situated on a PCB of a memory system or a data system.

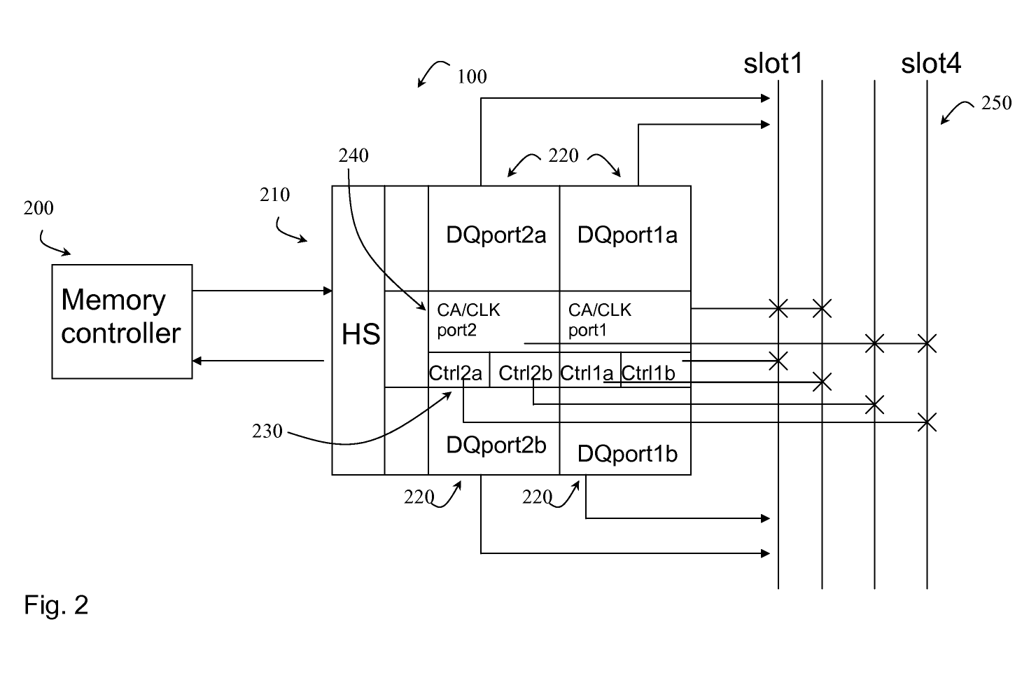

FIG. 2 illustrates one embodiment of buffer device 100 where configured to operate on a PCB, as previously described. Buffer device 100 may be connected to several slots 250 which are arranged on the PCB or board, respectively. The PCB or board may correspond to a main board of a computer, personal computer, server, host, client device or the like.

According to one embodiment illustrated in FIG. 2, memory controller 200 is connected to buffer device 100. According to FIG. 2, memory controller 200 is typically connected by using a bidirectional signal line or data bus, and may be simultaneously connected via a central processing unit (CPU, not illustrated) of a host computer, to buffer device 100. Memory controller 200 may be adapted to communicate with buffer device 100 by using a predefined data protocol. Accordingly, memory controller 200 may send read or write commands to buffer device 100 which in turn will communicate with a plurality of memory devices placed into the slots 250. These memory devices could be DDR3 registered DIMMS but other configurations or architectures are conceivable without departing from the spirit of the invention.

According to one embodiment the buffer device may include high speed interface (HS) 210 which connects buffer device 100 for communication to memory controller 200. Internally, buffer device 100 may include a logic circuitry as an integrated semiconductor circuit which is schematically illustrated by reference number 240. Additionally, buffer device 100 includes a plurality of ports 220 and 230 which are adapted to convey data or control signals respectively. Logic circuitry 240, connected to the high speed interface, receives commands from memory controller 200.

According to the embodiment in FIG. 2, slots 250 may be engaged with, for example, a four rank DIMM architecture although other combinations are conceivable. According to this embodiment a buffer-on-board architecture is implemented. That is, each of the plurality of control ports 230 may operate independently sending control signals to each slot 251.

The control ports 230 may be adapted to operate independently. Thus, each control port 230 (Ctr11a, Ctr11b, Ctr12a, Ctr12b) are independent from each other so that each slot 250 may be independently be controlled. The logic unit within buffer device 100 controls the operational mode of the buffer device. With reference to FIG. 2 a buffer-on-board implementation is realized. According to one embodiment, each control port 230 includes four chip select signals, four clock enable signals and accordingly two on-die terminations. This setup is mentioned only by the way of example. Additionally, the buffer device includes two command/address ports 240 (port 1 and port 2) and two clock ports, for example.

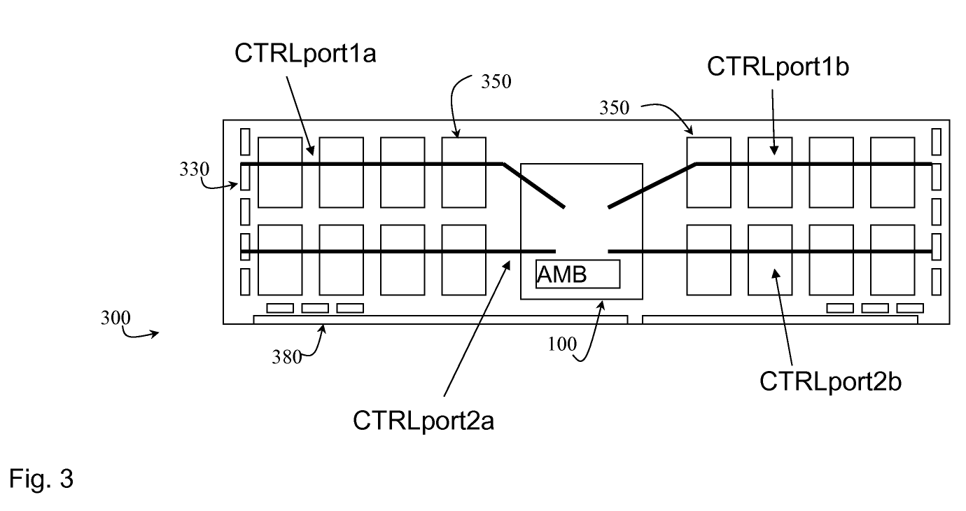

FIG. 3 illustrates one embodiment wherein buffer device 100 is adapted to operate as a buffer on DIMM device.

According to FIG. 3, a fully buffered DIMM device (FBDIMM) 300 is illustrated and buffer device 100 may operate as an advanced memory buffer (AMB) to control the communication between a CPU or a memory controller and each single DRAM device 350. Other architectures are, of course, conceivable and this FBDIMM architecture is only illustrated by the way of example.

DIMM module 300 is populated with a plurality (in this case 16) DRAM devices 350 and each DRAM device 350 may be implemented in a stacked form or a multi chip package (MCP) including at least two DRAM devices. Buffer device 100 communicates with the CPU (not illustrated) which may be installed on a motherboard of a device such as a computer, whereon the FBDIMM 300 is also mounted. Buffer device 100 is connected to the CPU by using interface 380. Interface 380 conveys the data from and to each DRAM on the DIMM by using buffer device 100.

According to the specific attributes of the FBDIMM implementation, the control ports of the AMB or buffer device 100 are not independent. That is, according to this embodiment CTRLPort1a and CTRLPort1b are copies of only one control port which means that the control port of buffer device 100 is duplicated and routed to the left and right side of the DIMM illustrated in FIG. 3. Analogous, the CTRLPort2a and CTRLPort2b are also duplicates (copies) of only one control port of buffer device 100.

In such configuration, buffer device 100 is adapted to operate as a buffer-on-DIMM device. This second mode of operation may be controlled by logic unit 130 (FIG. 1) within buffer device 100. The operational mode of the logic unit in such a case may be similar to that described with reference to FIG. 1. According to one example the AMB or buffer device 100, respectively may receive a BIOS signal during a power up sequence of a computer to cause logic unit 130 to switch buffer device 100 to one of a first or second mode of operation.

However, the buffer device may be used as a buffer-on-board or a buffer-on-DIMM device. According to other embodiments the switching between these two operational modes may be realized by using electrical fuses or the like which are programmable according to desired operational conditions. For instance a software program may control the operational mode of the buffer device 100.

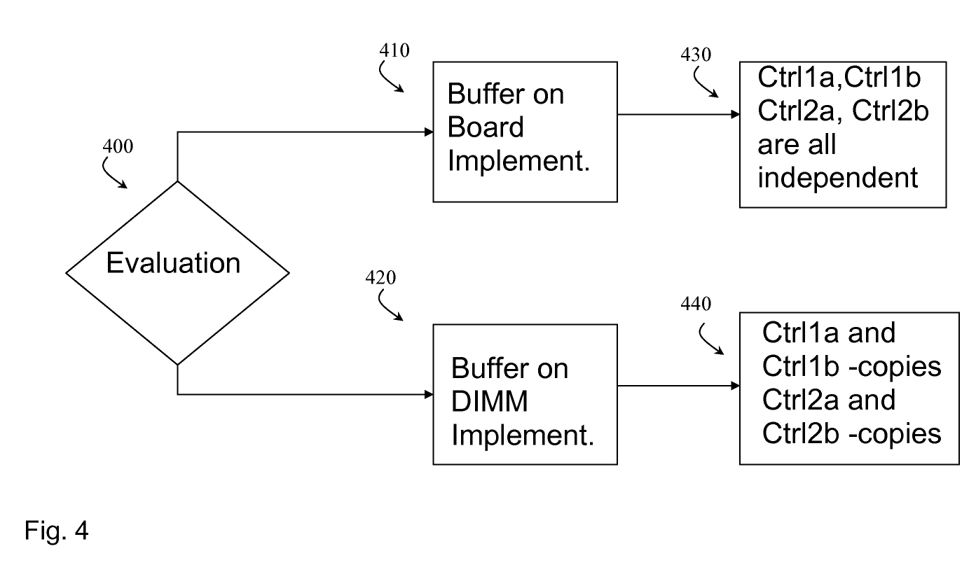

FIG. 4 schematically illustrates the operation of buffer device 100, controlled by using the logic unit within the buffer device. The evaluation process may be performed within logic unit 130 and be based on a software program for instance. The logic unit may also evaluate the information within a BIOS signal. After evaluating process 400, buffer device 100 may operate according to a buffer-on-board implementation 410 or a buffer-on-DIMM implementation 420. The buffer-on-board implementation is characterized, among other things, by four control ports which are independent from each other 430. The buffer-on-DIMM implementation 420 is likewise characterized by only two independent ports 440 which are subsequently duplicated and routed on the DIMM as illustrated with reference to FIG. 3.

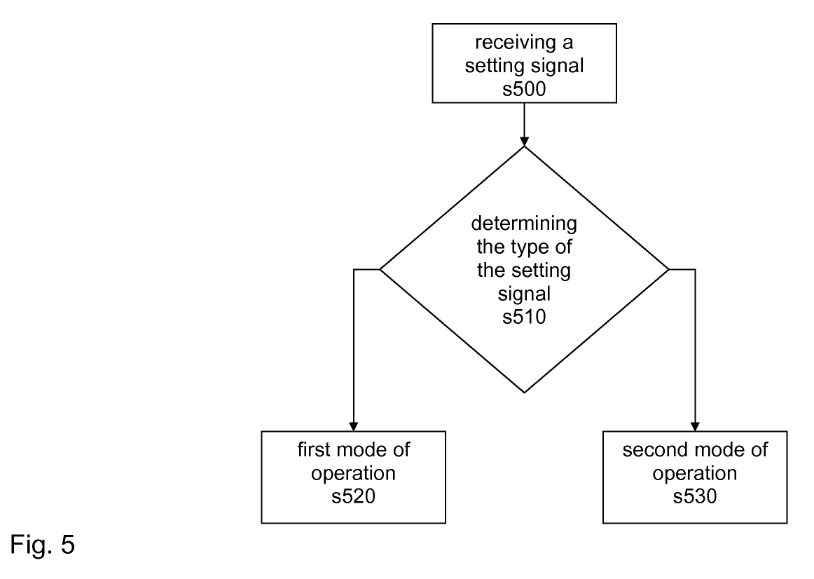

FIG. 5 illustrates an operational sequence of logic unit 130 according to one embodiment. Logic unit 130 may be implemented within buffer device 100 and is adapted to receive external signals, for instance. The external signal may be received from a CPU or a BIOS chip during the power up sequence of a computer.

At S500, a setting signal may be received. Subsequently a determination S510 may be performed wherein the type of the setting signal received in S500 is to be evaluated.

Based on the evaluation S510 of the received setting signal a first mode of operation S510 or a second mode of operation S530 of buffer device 100 may be set. According to an embodiment the first mode of operation may correspond to a buffer-on-board architecture wherein the buffer device is controlled to provide four independent control ports. The second mode of operation may correspond to a buffer-on-DIMM architecture wherein the buffer device is mounted on a DIMM module and is adapted to operate only two control ports which are subsequently duplicated to emulate four control ports.

However by using logic unit 130 the same integrated circuit may be used for two operational modes without re-designing buffer device 100.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An integrated circuit with a buffer device, comprising:
an interface to be operated according to an operation mode of the buffer device;
a receiving unit to receive at least a setting signal; and
a logic unit to control the operation mode of the buffer device based on the setting signal.

2. The integrated circuit of claim 1, comprising wherein the buffer device is a memory controller.

3. The integrated circuit of claim 1, wherein the interface comprises a plurality of control ports.

4. The integrated circuit of claim 1, comprising a plurality of data ports.

5. A memory module, comprising:
the buffer device of claim 1; and
a plurality of memory devices.

6. A memory system, comprising:
at least one memory module, the module including a plurality of memory devices; and
the buffer device of claim 1 to control the memory modules, the buffer device being arranged on the at least one memory module.

7. The memory system of claim 6, comprising wherein the system is a fully buffered dual inline memory module.

8. A system, comprising:
at least one memory module, the module including a plurality of memory devices; and
the buffer device of claim 1 to control the memory modules, the buffer device being arranged on a mother board of the system.

9. The system of claim 8, further comprising:
a central processing unit connected to the buffer device, the central processing unit being adapted to control the system;
a user interface unit; and
an external storage unit.

10. A method for controlling an operation mode of a buffer device, comprising:
receiving at least one setting signal;
controlling the buffer device by setting the operation mode based on the at least one setting signal; and
wherein the buffer device is an advanced memory buffer configured to control a plurality of memory devices.

11. The method of claim 10, comprising wherein the AMB is a dual operation mode AMB.

12. The method of claim 10, comprising wherein the operation mode is a buffer device on board operation mode or a buffer device on dual inline memory module operation mode.

13. A data system, comprising:
an integrated circuit with a buffer device, having an interface to be operated according to an operation mode of the buffer device, a receiving unit to receive at least a setting signal and a logic unit to control the operation mode of the buffer device based on the setting signal; and
a central processing unit in connection with the integrated circuit.

14. The data system of claim 13, comprising an user interface and at least one storage means.

15. The data system of claim 13, further comprising a BIOS device to provide the logic unit with a setting signal.

16. The data system of claim 12, comprising wherein the setting signal defines at least one mode of operation of the buffer device.

17. The data system of claim 16, comprising wherein the first mode of operation is a buffer on board mode of operation.

18. The data system of claim 16, comprising wherein a second mode of operation is a buffer on DIMM mode of operation.

19. A Computer program comprising program code to execute the operational sequence of claim 10
